(19) United States
(12) Patent Application Publication
(10) Pub. No.: US 2024/0136864 A1
(43) Pub. Date: Apr. 25, 2024

(54) WIRELESS POWER TRANSMISSION DEVICE AND OPERATION METHOD THEREOF

(71) Applicant: Richtek Technology Corporation, Zhubei City (TW)

(72) Inventors: Fu-Chi LIN, Hsinchu City (TW); Po-Chang CHEN, Huwei Township (TW); Wen-Ti LO, Hukou Township (TW)

(21) Appl. No.: 18/150,945

(22) Filed: Jan. 6, 2023

(30) Foreign Application Priority Data
Oct. 19, 2022 (TW) 111139819

(51) Int. Cl. H02J 50/80; H02J 50/10

(52) U.S. Cl. CPC H02J 50/80; H02J 50/10

(57) ABSTRACT

A wireless power transmission device includes a transmission device and a control device. The control device generates a driving signal to the transmission device in a first soft-start period, so as to drive the transmission device. The control device measures an energy message generated by the transmission device to generate a measurement result in a measurement period, and calculates a signal parameter according to the measurement result. The control device accordingly generates a carrier signal according to the signal parameter obtained by the measurement period in a second soft-start period. In a transmission period, the carrier signal is transmitted to the wireless power-receiving device through the transmission device. The energy message is generated by the transmission device in response to a distance between the transmission device and the wireless power-receiving device.

### CROSS REFERENCE TO RELATED APPLICATIONS

This application claims priority of Taiwan Patent Application No. 111139819, filed on Oct. 20, 2022, the entirety of which is incorporated by reference herein.

### TECHNICAL FIELD

The present invention relates to a transmission device, and in particular it relates to a wireless power transmission device and an operation method thereof.

### BACKGROUND

In general, in a wireless power transmission system, a wireless power transmission terminal may provide a carrier with a fixed energy to a wireless power receiving terminal, so that the wireless power receiving terminal operates accordingly. The distance between the wireless power transmission terminal and the wireless power receiving terminal may change, however (i.e., it is not fixed). If the wireless power transmission terminal still provides the carrier with a fixed energy to the wireless power-receiving device, it may cause the distance between the wireless power-receiving device and the wireless power transmission device to be short. If this happens, the wireless power receiving terminal receiving the carrier with the strong energy may malfunction. Alternatively, when the distance between the wireless power receiving terminal and the wireless power transmission device is long, the receiving quality of the carrier of the wireless power-receiving device may suffer.

Therefore, how to effectively provide a carrier with suitable energy has become a focus for technical improvements by various manufacturers.

### SUMMARY

An embodiment of the present invention provides a wireless power transmission device and an operation method thereof, such that it provides a suitable carrier signal adaptively, according to the change in distance between the wireless power transmission device and the wireless power-receiving device, so as to increase the convenience of use.

An embodiment of the present invention provides a wireless power transmission device, which includes a transmission device and a control device. The control device generates a driving signal to the transmission device in a first soft-start period, so as to drive the transmission device. The control device measures the energy message generated by the transmission device to generate a measurement result in a measurement period, and calculates a signal parameter according to the measurement result. The control device accordingly generates a carrier signal according to the signal parameter obtained by the measurement period in a second soft-start period. In a transmission period, the carrier signal is modulated and transmitted to the wireless power-receiving device through the transmission device. The energy message is generated by the transmission device in response to a distance between the transmission device and the wireless power-receiving device.

An embodiment of the present invention provides an operation method of a wireless power transmission device, which includes the following steps. In a first soft-start period, a driving signal is generated to a transmission device, so as to drive the transmission device. In a measurement period, the energy message generated by the transmission device is measured to generate a measurement result, and a signal parameter is calculated according to the measurement result, wherein the energy message is generated by the transmission device in response to a distance between the transmission device and the wireless power-receiving device. In a second soft-start period, a carrier signal is accordingly generated according to the signal parameter obtained by the measurement period. In a transmission period, modulating and transmitting the carrier signal to the wireless power-receiving device through the transmission device.

According to the wireless power transmission device and the operation method thereof disclosed by the present invention, in the first soft-start period, the driving signal is generated to the transmission device, so as to drive the transmission device. In the measurement period, the energy message generated by the transmission device is measured to generate the measurement result, and the signal parameter is calculated according to the measurement result. In the second soft-start period, the carrier signal is accordingly generated according to the signal parameter obtained by the measurement period. In the transmission period, the carrier signal is modulated and transmitted to the wireless power-receiving device through the transmission device. Therefore, it may effectively provide a suitable carrier signal adaptively, according to the change in distance between the wireless power transmission device and the wireless power-receiving device, so as to increase the convenience of use.

### BRIEF DESCRIPTION OF DRAWINGS

The present invention can be more fully understood by reading the subsequent detailed description and examples with references made to the accompanying drawings, wherein:

FIG. 1 is a schematic view of an electronic device according an embodiment of the present invention;

FIG. 2 is a circuit block diagram of an electronic device according an embodiment of the present invention;

FIG. 3 is a timing diagram of the operation of the wireless power transmission device according an embodiment of the present invention;

FIG. 4A is a schematic view of a corresponding relationship of a measurement current or a measurement voltage of a measurement result and a frequency of a signal parameter according an embodiment of the present invention;

FIG. 4B is a schematic view of a corresponding relationship of a measurement current or a measurement voltage of a measurement result and a duty cycle of a signal parameter according an embodiment of the present invention;

FIG. 4C is a schematic view of a corresponding relationship of a measurement current or a measurement voltage of a measurement result and an applied voltage of a signal parameter according an embodiment of the present invention;

FIG. 5 is a flowchart of an operation method of a wireless power transmission device according an embodiment of the present invention; and

FIG. 6 is a flowchart of an operation method of a wireless power transmission device according another embodiment of the present invention.

### DETAILED DESCRIPTION OF DISCLOSED EMBODIMENTS

Technical terms of the present invention are based on general definition in the technical field of the present invention. If the present invention describes or explains one or some terms, definition of the terms is based on the description or explanation of the present invention. Each of the disclosed embodiments has one or more technical features. In possible implementation, a person skilled in the art would selectively implement all or some technical features of any embodiment of the present invention or selectively combine all or some technical features of the embodiments of the present invention.

In each of the following embodiments, the same reference number represents an element or component that is the same or similar.

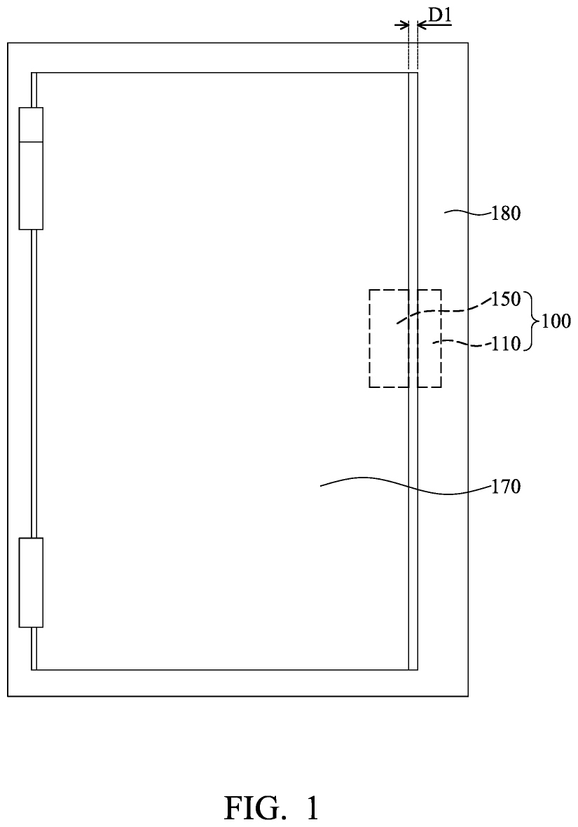

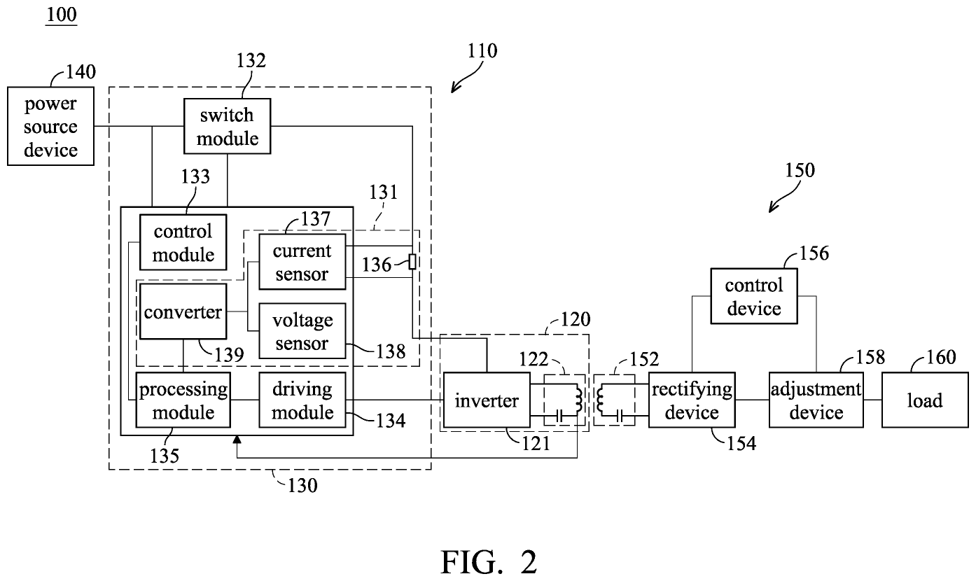

FIG. 1 is a schematic view of an electronic device according an embodiment of the present invention. FIG. 2 is a circuit block diagram of an electronic device according an embodiment of the present invention. In the embodiment, the electronic device 100 is, for example, an electronic lock, and the electronic device 100 may be disposed on a door 170 and a doorframe 180, but the embodiment of the present invention is not limited thereto. Please refer to FIG. 1 and FIG. 2. The electronic device 100 may include a wireless power transmission device 110 and a wireless power-receiving device 150. In the embodiment, the wireless power transmission device 110 is, for example, fixed on the doorframe 180, and the wireless power-receiving device 150 is, for example, disposed on the door 170 and may move as the door 170 is opened or closed.

The wireless power transmission device 110 may at least include a transmission device 120 and a control device 130. Furthermore, the transmission device 120 may include an inverter 121 and a coil unit 122. In the embodiment, the inverter 121 is, for example, a half-bridge inverter or a full-bridge inverter, but the embodiment of the present invention is not limited thereto. The coil unit 122 may be coupled to the inverter 121, and may transmit a carrier signal to the wireless power-receiving device 150. In addition, the above carrier signal is, for example, a carrier signal with digital ping.

The control device 130 is coupled to the transmission device 120. Furthermore, the control device 130 may include a sensing module 131, a switch module 132, a control module 133, a driving module 134 and a processing module 135. The sensing module 131 is coupled to the transmission device 120, and measures the energy message of the transmission device to generate a measurement result. The switch module 132 receives a power source signal. The control module 133 is coupled to the switch module 132, and controls the switch module 132, so as to turn on or turn off the switch module 132. In the embodiment, the control module 133 is, for example, a micro control unit. In addition, the driving module 134 is, for example, a pulse width modulator (PWM).

The processing module 135 is coupled to the sensing module 131, the control module 133 and the driving module 134. The processing module 135 may control the driving module 134 and the control module 133 to generate a driving signal to the transmission device 120, so as to drive the transmission device 120. The processing module 135 may calculate a signal parameter according to the measurement result of the sensing module 131, and control the driving module 134 and the control module 133 to generate a carrier signal according to the signal parameter. In the embodiment, the processing module 135 is, for example, a microprocessor.

The wireless power-receiving device 150 may include a transmission device 152, a rectifying device 154, a control device 156, an adjustment device 158 and a load 160. The transmission device 152 may communicate with the transmission device 120 in a wireless manner, and receive and transmit the carrier signal through the transmission device 120. The rectifying device 154 is coupled to the transmission 152, receives the carrier signal, and rectifies the carrier signal to generate a rectified signal. The control device 156 is coupled to the rectifying device 154, and receives the rectified signal to operate. The adjustment device 158 is coupled to the rectifying device 154 and the control device 156, receives the rectified signal, adjusts the rectified signal according to a control of the control device 156, and provides the adjusted rectified signal to the load 160, such that the load 160 operates accordingly. In the embodiment, the rectifying device 154 is, for example, a rectifier, the control device 156 is, for example, a micro control unit, and the adjustment device 158 is, for example, a DC-DC regulator.

Furthermore, the sensing module 131 may include a sensing resistor 136, a current sensor 137, a voltage sensor 138 and a converter 139. The sensing resistor 136 is coupled between the switch module 132 and the inverter 121 of the transmission device 120. The current sensor 137 is coupled to the sensing resistor 136, and senses a current flowing through the sensing resistor 136 (i.e., the current of the inverter 121) to generate a current sensing signal.

The voltage sensor 138 is coupled to the coil unit 122 of the transmission device 120, and senses the voltage of the coil unit 122 to generate a voltage sensing signal. The converter 139 is coupled to the current sensor 137, the voltage sensor 138 and the processing module 135, receives the current sensing signal and the voltage sensing signal, and provides the current sensing signal and the voltage sensing signal to the processing module 135, such that the processing module 135 accordingly calculate the signal parameter. In the embodiment, the converter 139 is, for example, an analog-to-digital converter (ADC). In addition, the wireless power transmission device 110 further include a power source device 140. The power source device 140 is coupled to the switch module 132, the control device 133, the driving module 134 and the processing module 135, and provides the power source signal.

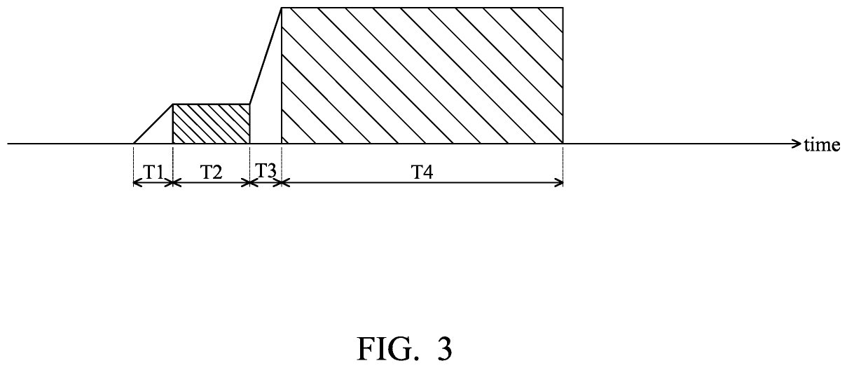

The internal components of the electronic device 100 and the coupling relationship of the internal components are described above, and the operation of the wireless power transmission device 110 is described below with a timing diagram. FIG. 3 is a timing diagram of the operation of the wireless power transmission device according an embodiment of the present invention. Please refer to FIG. 1 to FIG. 3. In a first soft-start period T1, the control device 130 may generate a driving signal to the transmission device 120, so as to drive the transmission device 120. That is, the processing module 135 may control the driving module 134 and the control module 133 to generate the driving signal to the transmission device 120.

Then, in a measurement period T2, the control device 130 may measure the energy message generated by the transmission device 120 to generate a measurement result, and calculates a signal parameter according to the measurement result, wherein the energy message is generated by the transmission device 120 in response to a distance D1 between the transmission device 120 and the wireless power-receiving device 150. For example, when the distance D1 between the transmission device 120 and the wireless power-receiving device 150 is short, the energy of the energy message of the transmission device 120 is high. When the distance D1 between the transmission device 120 and the wireless power-receiving device 150 is long, the energy of the energy message of the transmission device 120 is low. In addition, the inverter 121 and the coil unit 122 may generate the energy message in response to the driving signal.

In the embodiment, the measurement result may include a measurement current (such as the current of the inverter 121) or a measurement voltage (such as the voltage of the coil unit 122), and the signal parameter may include a frequency, a duty cycle and an applied voltage. In addition, the frequency and the duty cycle of the signal parameter may be parameters used to control the driving module 134 to generate the carrier signal. The applied voltage of the signal parameter may be a parameter used to control the control module 133 to generate the carrier signal.

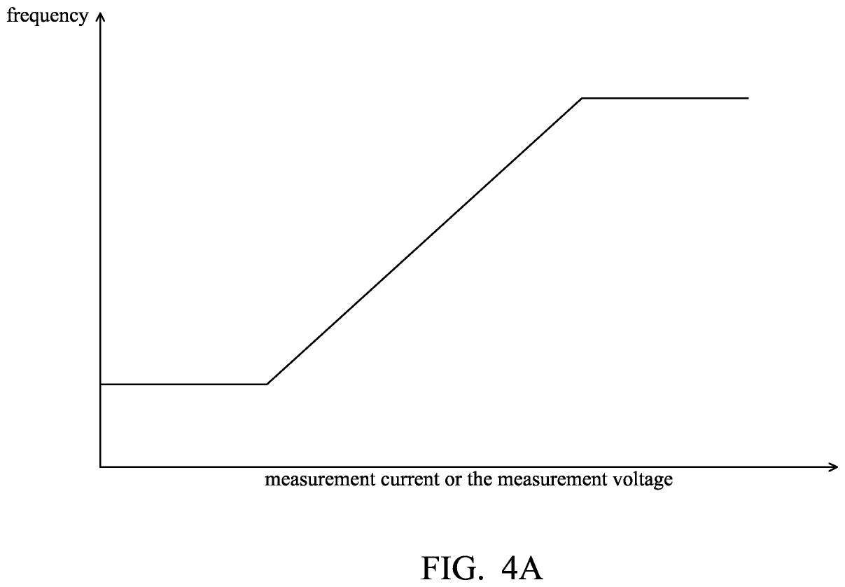

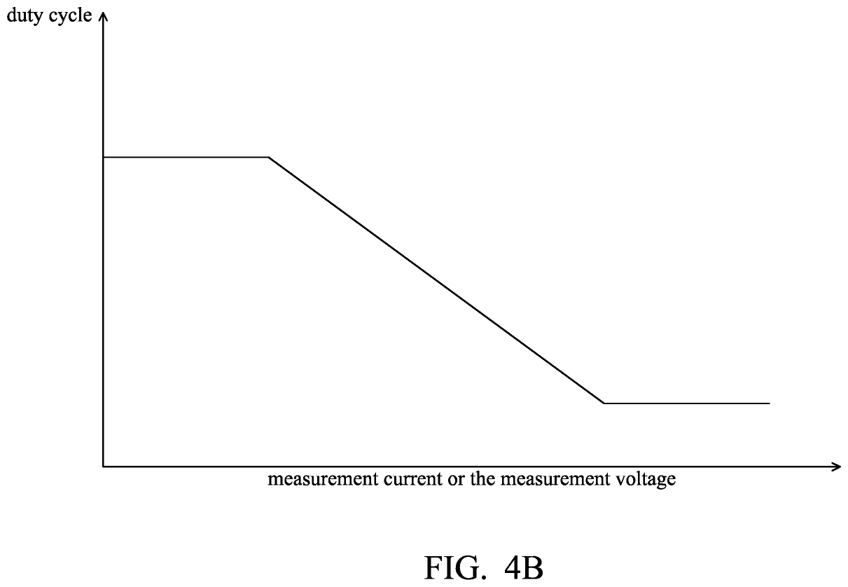

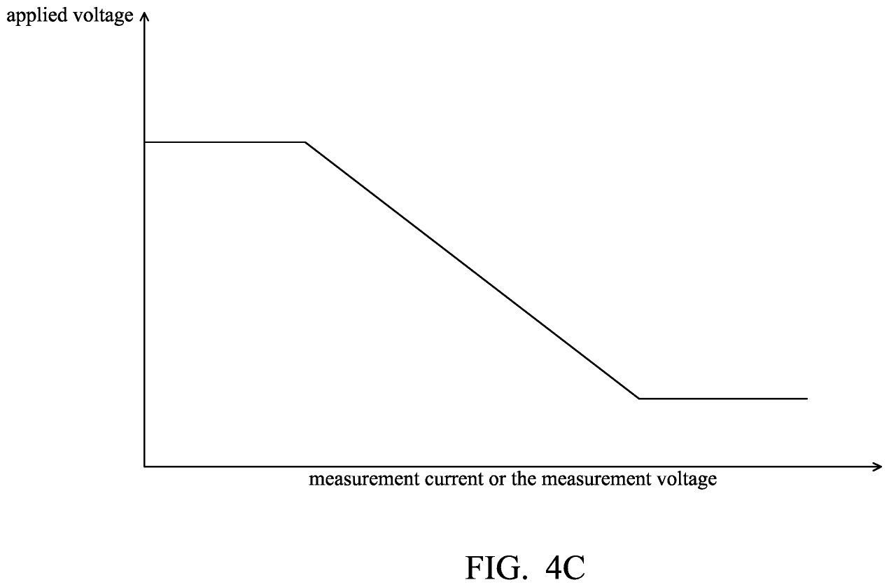

In some embodiments, the frequency of the signal parameter is, for example, proportional to the measurement current or the measurement voltage of the measurement result, as shown in FIG. 4A. For example, when the control device 130 determines that the measurement current of the measurement voltage of the measurement result is high, it indicates that the distance D1 between the transmission device 120 and the wireless power-receiving device 150 is short, and the control device 130 accordingly generates the signal parameter with a higher frequency to the driving module 134. When the control device 130 determines that the measurement current or the measurement voltage of the measurement result is low, it indicates that the distance D1 between the transmission device 120 and the wireless power-receiving device 150 is long, and the control device 130 accordingly generates the signal parameter with a lower frequency to the driving module 134.

In some embodiments, the duty cycle of the signal parameter is, for example, inversely proportional to the measurement current or the measurement voltage of the measurement result, as shown in FIG. 4B. For example, when the control device 130 determines that the measurement current or the measurement voltage of the measurement result is high, it indicates that the distance D1 between the transmission device 120 and the wireless power-receiving device 150 is short, and the control device 130 accordingly generate the signal parameter with a lower duty cycle to the driving module 134. When the control device 130 determines that the measurement current or the measurement voltage of the measurement result is low, it indicates that the distance D1 between the transmission device 120 and the wireless power-receiving device 150 is long, and the control device 130 accordingly generate the signal parameter with a higher duty cycle to the driving module 134.

In some embodiments, the applied voltage of the signal parameter is, for example, inversely proportional to the measurement current or the measurement voltage of the measurement result, as shown in FIG. 4C. For example, when the control device 130 determines that the measurement current or the measurement voltage of the measurement result is high, it indicates that the distance D1 between the transmission device 120 and the wireless power-receiving device 150 is short, and the control device 130 accordingly generates the signal parameter with a lower applied voltage to the control module 133. When the control device 130 determines that the measurement current or the measurement voltage of the measurement result is high, it indicates that the distance D1 between the transmission device 120 and the wireless power-receiving device 150 is long, and the control device 130 accordingly generate the signal parameter with a higher applied voltage to the control module 133.

Afterward, in a second soft-start period T3, the control device 130 accordingly generates the carrier signal according to the signal parameter obtained by the measurement period T2. That is, the control device 130 may generate the carrier signal corresponding to the signal parameter according to the frequency, duty cycle and/or the applied voltage of the above signal parameter. For example, the control module 133 may generate the carrier signal according to the applied voltage of the signal parameter, and/or the driving module 134 may generate the carrier signal according to the frequency and/or the duty cycle of the signal parameter.

Then, in a transmission period T4, the carrier signal generated by the control device 130 is transmitted to the wireless power-receiving device 150 through the transmission device 120. Therefore, the control device 130 may obtain the distance between the transmission device 120 and the wireless power-receiving device 150 according to the measurement result 120 and adaptively adjust and generate the signal parameter corresponding the carrier signal, so as to generate the suitable carrier signal to the wireless power-receiving device 150. Accordingly, it is possible to prevent the wireless power-receiving device 150 from malfunctioning due to receiving a carrier with too much energy, or it possible to prevent from the situation that the receiving quality of carrier signal is poor.

In the embodiment, the voltage of the driving signal is, for example, lower than the voltage of the carrier signal. In addition, in the embodiment, the first soft-start period T1, the measurement period T2 and the second the soft-start period T3 are, for example, shorter than the transmission period T4. For example, the first soft-start period T1 is, for example, shorter than or equal to 1/10 of the transmission period T4 (i.e., T1≤( 1/10)*T4), the measurement period T2 is, for example, shorter than or equal to 1/10 of the transmission period T4 (i.e., T2≤( 1/10)*T4), and the second the soft-start period T3 is, for example, shorter than or equal to 1/10 of the transmission period T4 (i.e., T3≤( 1/10)*T4), but the embodiment of the present invention is not limited thereto.

Afterward, after the control device 130 transmits the carrier signal to the wireless power-receiving device 150 through the transmission device 120, the control device 130 may further detect there is a response message from the wireless power-receiving device 150 through the transmission device 120, wherein the response message is generated by the wireless power transmission device 150 in response to the carrier signal. That is, the control device 130 may detect whether the wireless power-receiving device 150 is adjacent to the transmission device 120 (the wireless power transmission device 110) or far away from the transmission device 120 (the wireless power transmission device 110).

When the control device 130 detects that there is the response message, it indicates that the door 170 is not opened and the wireless power-receiving device 150 is adjacent to the transmission device 120 (the wireless power transmission device 110), and the control device 130 continuously provides the carrier signal, so as to maintain the operation of the wireless power-receiving device 150. When the control device 130 detects that there is no response message, it indicates that the door 170 is opened and the wireless power-receiving device 150 is far away from the transmission device 120 (the wireless power transmission device 110), and the control device 130 may stop providing the carrier signal. For example, the control device 130 stops providing the carrier signal in a soft shutdown mode.

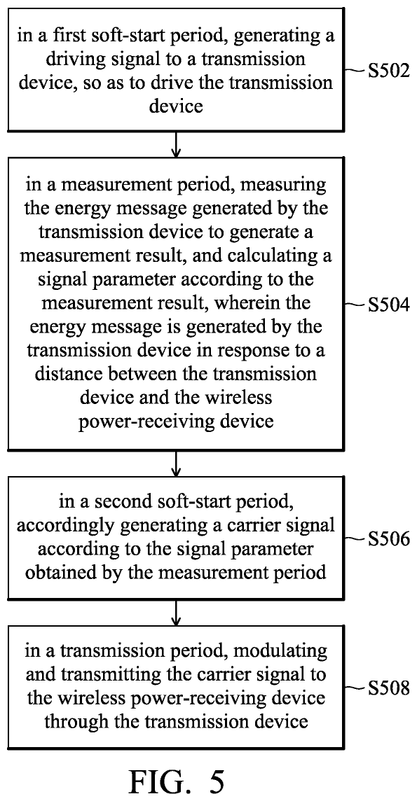

FIG. 5 is a flowchart of an operation method of a wireless power transmission device according an embodiment of the present invention. In step S502, the method involves in a first soft-start period, generating a driving signal to a transmission device, so as to drive the transmission device. In step S504, the method involves in a measurement period, measuring the energy message generated by the transmission device to generate a measurement result, and calculating a signal parameter according to the measurement result, wherein the energy message is generated by the transmission device in response to a distance between the transmission device and the wireless power-receiving device. In step S506, the method involves in a second soft-start period, accordingly generating a carrier signal according to the signal parameter obtained by the measurement period. In step S508, the method involves in a transmission period, modulating and transmitting the carrier signal to the wireless power-receiving device through the transmission device.

In some embodiments, the measurement result includes, for example, a measurement current or a measurement voltage, and the signal parameter includes a frequency, a duty cycle and an applied voltage. In some embodiments, the frequency of the signal parameter is, for example, proportional to the measurement current or the measurement voltage of the measurement result. In some embodiments, the duty cycle of the signal parameter is, for example, inversely proportional to the measurement current or the measurement voltage of the measurement result. In some embodiments, the applied voltage of the signal parameter is, for example, inversely proportional to the measurement current or the measurement voltage of the measurement result. In some embodiments, the voltage of the driving signal is, for example, lower than the voltage of the carrier signal. In some embodiments, the first soft-start period, the measurement period and the second the soft-start period are, for example, shorter than the transmission period. In some embodiments, when the distance between the transmission device and the wireless power-receiving device is short, the energy of the energy message of the transmission device is high, and when the distance between the transmission device and the wireless power-receiving device is long, the energy of the energy message of the transmission device is low.

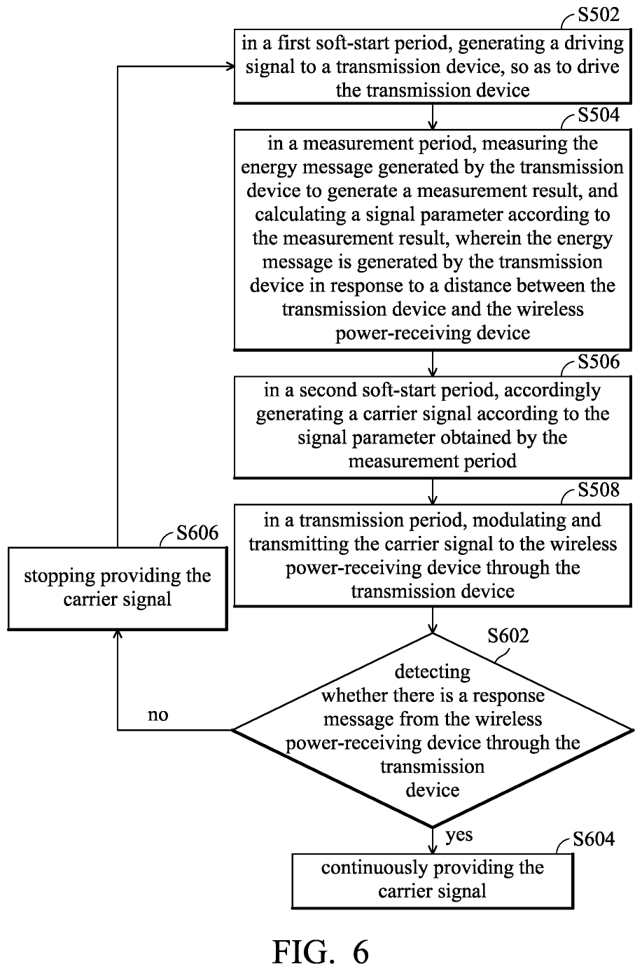

FIG. 6 is a flowchart of an operation method of a wireless power transmission device according another embodiment of the present invention. In the embodiment, steps S502-S508 in FIG. 6 are the same as or similar to steps S502-S508 in FIG. 5. Accordingly, steps S502-S508 in FIG. 6 may refer to the description of the embodiment of FIG. 5, and the description thereof is not repeated herein.

In step S602, the method involves detecting whether there is a response message from the wireless power-receiving device through the transmission device, wherein the response message is generated by the wireless power transmission device in response to the carrier signal. When detecting that there is the response message, the method performs step S604. In step S604, the method involves continuously providing the carrier signal. When detecting that there is no response message, the method performs step S606. In step S606, the method involves stopping providing the carrier signal.

In summary, according to the wireless power transmission device and the operation method thereof disclosed by the embodiment of the present invention, in the first soft-start period, the driving signal is generated to the transmission device, so as to drive the transmission device. In the measurement period, the energy message generated by the transmission device is measured to generate the measurement result, and the signal parameter is calculated according to the measurement result. In the second soft-start period, the carrier signal is accordingly generated according to the signal parameter obtained by the measurement period. In the transmission period, the carrier signal is modulated and transmitted to the wireless power-receiving device through the transmission device. Therefore, it may effectively provide a suitable carrier signal adaptively according to the change in distance between the wireless power transmission device and the wireless power-receiving device, so as to increase the convenience of use.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A wireless power transmission device, comprising:
a transmission device; and
a control device, wherein the control device generates a driving signal to the transmission device in a first soft-start period, so as to drive the transmission device, the control device measures an energy message generated by the transmission device to generate a measurement result in a measurement period, and calculates a signal parameter according to the measurement result, the control device accordingly generates a carrier signal according to the signal parameter obtained by the measurement period in a second soft-start period, and in a transmission period, the carrier signal is transmitted to the wireless power-receiving device through the transmission device;
wherein the energy message is generated by the transmission device in response to a distance between the transmission device and the wireless power-receiving device.

2. The wireless power transmission device as claimed in claim 1, wherein the transmission device comprises:
an inverter; and
a coil unit, coupled to the inverter, and configured to transmit the carrier signal to the wireless power-receiving device;
wherein the inverter and the coil unit generate the energy message in response to the driving signal.

3. The wireless power transmission device as claimed in claim 1, wherein the control device comprises:
a sensing module, configured to measure the energy message of the transmission device to generate the measurement result;
a switch module, configured to receive a power source signal;
a control module, configured to control the switch module;
a driving module; and
a processing module, configured to control the driving module and the control module to generate the driving signal, calculate the signal parameter according to the measurement result, and control the driving module and the control module to generate the carrier signal according to the signal parameter.

4. The wireless power transmission device test device as claimed in claim 1, wherein the measurement result comprises a measurement current or a measurement voltage, and the signal parameter comprises a frequency, a duty cycle and an applied voltage.

5. The wireless power transmission device as claimed in claim 4, wherein the frequency of the signal parameter is proportional to the measurement current or the measurement voltage of the measurement result.

6. The wireless power transmission device as claimed in claim 4, wherein the duty cycle of the signal parameter is inversely proportional to the measurement current or the measurement voltage of the measurement result.

7. The wireless power transmission device as claimed in claim 4, wherein the applied voltage of the signal parameter is inversely proportional to the measurement current or the measurement voltage of the measurement result.

8. The wireless power transmission device as claimed in claim 1, wherein the control device further detects whether there is a response message from the wireless power-receiving device through the transmission device, when the control device detects that there is the response message, the control device continuously provides the carrier signal, and when the control device detects that there is no response message, the control device stops providing the carrier signal, wherein the response message is generated by the wireless power transmission device in response to the carrier signal.

9. The wireless power transmission device as claimed in claim 2, wherein a voltage of the driving signal is lower than a voltage of the carrier signal.

10. The wireless power transmission device as claimed in claim 1, wherein the first soft-start period, the measurement period and the second the soft-start period are shorter than the transmission period.

11. The wireless power transmission device as claimed in claim 1, wherein when the distance between the transmission device and the wireless power-receiving device is short, an energy of the energy message of the transmission device is high, and when the distance between the transmission device and the wireless power-receiving device is long, the energy of the energy message of the transmission device is low.

12. An operation method of a wireless power transmission device, comprising:
in a first soft-start period, generating a driving signal to a transmission device, so as to drive the transmission device;
in a measurement period, measuring an energy message generated by the transmission device to generate a measurement result, and calculating a signal parameter according to the measurement result, wherein the energy message is generated by the transmission device in response to a distance between the transmission device and the wireless power-receiving device;
in a second soft-start period, accordingly generating a carrier signal according to the signal parameter obtained by the measurement period; and
in a transmission period, transmitting the carrier signal to the wireless power-receiving device through the transmission device.

13. The operation method of the wireless power transmission device as claimed in claim 12, wherein the measurement result comprises a measurement current or a measurement voltage, and the signal parameter comprises a frequency, a duty cycle and an applied voltage.

14. The operation method of the wireless power transmission device as claimed in claim 13, wherein the frequency of the signal parameter is proportional to the measurement current or the measurement voltage of the measurement result.

15. The operation method of the wireless power transmission device as claimed in claim 13, wherein the duty cycle of the signal parameter is inversely proportional to the measurement current or the measurement voltage of the measurement result.

16. The operation method of the wireless power transmission device as claimed in claim 13, wherein the applied voltage of the signal parameter is inversely proportional to the measurement current or the measurement voltage of the measurement result.

17. The operation method of the wireless power transmission device as claimed in claim 12, further comprising:
detecting whether there is a response message from the wireless power-receiving device through the transmission device, wherein the response message is generated by the wireless power transmission device in response to the carrier signal;
when detecting that there is the response message, continuously providing the carrier signal; and
when detecting that there is no response message, stopping providing the carrier signal.

18. The operation method of the wireless power transmission device as claimed in claim 12, wherein a voltage of the driving signal is lower than a voltage of the carrier signal.

19. The operation method of the wireless power transmission device as claimed in claim 12, wherein the first soft-start period, the measurement period and the second the soft-start period are shorter than the transmission period.

20. The operation method of the wireless power transmission device as claimed in claim 12, wherein when the distance between the transmission device and the wireless power-receiving device is short, an energy of the energy message of the transmission device is high, and when the distance between the transmission device and the wireless power-receiving device is long, the energy of the energy message of the transmission device is low.
